(19) United States
(12) Patent Application Publication
(10) Pub. No.: US 2020/0066181 A1
(43) Pub. Date: Feb. 27, 2020

(54) Generating Personalized Food Recommendations from Different Food Sources

(71) Applicant: Zoe Global Ltd., London (GB)

(72) Inventors: George Hadjigeorgiou, London (GB); Jonathan Thomas Wolf, London (GB); Richard James Davies, London (GB)

(73) Assignee: Zoe Global Ltd.

(21) Appl. No.: 16/120,039

(22) Filed: Aug. 31, 2018

Related U.S. Application Data
(60) Provisional application No. 62/723,424, filed on Aug. 27, 2018.

(51) Int. Cl. G09B 19/00

(52) U.S. Cl. CPC G09B 19/0092

(57) ABSTRACT

Techniques are disclosed herein for generating personalized nutritional recommendations for foods available from one or more food sources. Using the technologies described herein, a programmatic analysis is performed on different data to predict values of personalized nutrition data, such as one or more target biomarkers, that are associated with an individual after eating the foods. Personalized nutritional recommendations for foods available from the food sources are then generated, using the predicted values, and provided to the individual. The predictions are based on data that is associated with the individual, such as microbiome data, triglycerides data, glucose data, nutritional data, questionnaire data, and the like. A prediction service can utilize a machine learning mechanism to generate the predicted personalized nutrition data. A nutrition service utilizes the predicted personalized nutrition data when generating the personalized nutritional recommendations.

### RELATED APPLICATION

This application claims priority to U.S. Provisional Patent Application No. 62/723,424, entitled “GENERATING PERSONALIZED NUTRITIONAL RECOMMENDATIONS USING PREDICTED VALUES OF BIOMARKERS”, filed on Aug. 27, 2018, and fully incorporated by this reference herein.

### BACKGROUND

Today, individuals have a large variety of food choices. Determining healthy food choices for an individual can be challenging. Complicating the selection of food that is healthy for a user include factors that are personal to the user. Age, sex, weight, health and the microbiome of an individual affect what foods an individual should select to eat. For example, while low-carbohydrate food or low-fat food may be beneficial for one individual, that same low-carbohydrate or low-fat food choice may not be beneficial for another individual. Even after an individual determines what foods work best for them, it can be difficult for the individual to select the food to eat.

### BRIEF DESCRIPTION OF THE DRAWINGS

FIG. 1 is a block diagram depicting an illustrative operating environment in which food recommendations are generated from different food sources;

FIG. 2 is a block diagram depicting an illustrative operating environment in which a data ingestion service receives and processes data from different food sources associated with generating food recommendations;

FIG. 3 is a block diagram depicting an illustrative operating environment in which a data ingestion service receives, and processes data associated with generating food recommendations personalized to an individual;

FIG. 4 is a block diagram depicting an illustrative operating environment in which a prediction service generates prediction of target biomarkers utilizing machine learning and data;

FIG. 5 is a block diagram depicting an illustrative operating environment in which a nutrition service generates personalized nutritional recommendations utilizing predicted values of target biomarkers;

FIG. 6 is a flow diagram showing a routine illustrating aspects of a mechanism disclosed herein for generating food recommendations from different sources;

FIG. 7 is a flow diagram showing a routine illustrating aspects of a mechanism disclosed herein for identifying foods from a menu;

FIG. 8 is a flow diagram showing a routine illustrating aspects of a mechanism disclosed herein for predicting values of target biomarkers;

FIG. 9 is a flow diagram showing a routine illustrating aspects of a mechanism disclosed herein for generating personalized nutritional recommendations for foods available from a food source; and

FIG. 10 is a computer architecture diagram showing one illustrative computer hardware architecture for implementing a computing device that might be utilized to implement aspects of the various examples presented herein.

### DETAILED DESCRIPTION

The following detailed description is directed to technologies for generating personalized food recommendations (which includes drinks) from different food sources. For example, a user might obtain personalized nutritional recommendations for selecting meals from a restaurant (which may be referred to herein as “foods” and includes drinks), foods from a food delivery service, foods from a grocery store, or foods from some other food source. Using the technologies described herein, a nutrition service generates personalized nutritional recommendations by analyzing the different foods available from the food sources combined with the user's personal health data. These recommendations may be based on predicted values of target biomarkers for the individual.

Food recommendations may be for a single meal or for a period of time where the combination of meals is optimized for the user. In some cases, the nutrition service will take a food or combination of foods selected by a user and advise them how to better optimize it by for example adding another food or changing quantity.

A “biomarker” or biological marker generally refers to a measurable indicator of some biological state or condition associated with an individual. Stated another way, a biomarker may be anything that can be used as an indicator of particular disease state or some other physiological state of an organism. A biomarker can typically be measured accurately (either objectively or subjectively) and the measurement is reproducible (e.g., blood glucose, triglycerides, insulin, c-peptide, ketone body ratios, IL-6 inflammation markers, hunger, fullness, and the like). Some biomarkers change rapidly after a meal (e.g. blood glucose or insulin), while others change slowly as a result of many meals (e.g. HbAlc or weight).

The different data utilized to generate the predicted values of the biomarkers and the generation of the personalized nutritional recommendations can include many different types of health data such as microbiome data, blood data, glucose data, ketone data, nutrition data, wearable data, genetic data, saliva data, biometric data, questionnaire data, psychological data (e.g., hunger, sleep quality, mood, . . . ), objective health data (e.g., age, sex, height, weight, medical history, . . . ), as well as other types of data. Generally, “health data” can refer to any psychological, subjective and/or objective data that relates to and is associated with one or more individuals. The health data might be obtained through testing, self-reporting, and the like.

In some examples, the data includes wearable data obtained from technology worn and/or utilized by an individual. For instance, an individual may wear a fitness device, such as an activity-monitoring device, that monitors motion, heart rate, determines how much a user has slept, the number of calories burned, activities performed, blood pressure, body temperature, and the like. The individual may also wear a continuous glucose meter that monitors blood glucose levels often by measuring levels of glucose in interstitial fluid.

An individual may also provide data that may be utilized to predict the target values and/or changes to the target values and generate the nutritional recommendations using other devices such as blood glucose monitors, finger pricks which in some examples are used with dried blood spot cards, blood pressure monitors, and the like. An individual may also input data into one or more software applications (or provide the data some other way) that can be utilized. For example, a user may enter the foods they had during a meal, how much they slept, what exercise they did, how hungry they are, how they feel, what medication they take, and the like. As another example, an individual may input test data determined from one or more tests, such as urinalysis test strips, blood test strips, and the like. The test data may come from different sources, such as but not limited to from one or more of an individual, a lab, a doctor, an organization, and/or some other data source.

An individual may also provide data about their food preferences, medical guidance they have received, or personalized food constraints such as being vegan or kosher.

Still further, in some cases, the individual can provide biological samples to a lab for testing. According to some configurations, users can provide a sample, such as a stool sample, for microbiome analysis. As an example, metagenomic testing can be performed using the sample to allow the DNA of a microbiome of an individual to be digitalized. Generally, a microbiome analysis includes determining the composition and function of a community of microorganisms in a particular location, such as within the gut of a user. An individual's microbiome appears to have a strong causal relationship to metabolism, weight and health, yet only ten to thirty percent of the microbiome is common across different individuals.

After accessing the different types of data from an individual, a prediction service identifies the predicted value of different target biomarkers as predicted after eating one or more foods available from the food source. In some configurations, the prediction service obtains food data that is available from a food source and generates personalized recommendations for the different food choices that are available from that food source.

The food that is available from a food source can be determined in different ways. In some configurations, an individual may take a digital picture of the menu that is then provided to the nutrition service for analysis. For example, the nutrition service may perform a graphical analysis of the digital image to identify the different meals and foods on the menu. analyzed to identify the different foods. In some configurations, such a digital image may be captured using the individual's smartphone camera. In some other examples, the foods may be available from some other source, such as a website, an online database, and the like.

After identifying the foods available from a food source, the prediction service is configured to generate the predicted values of different target biomarkers for all or a portion of the foods. For example, the prediction service may generate predictions for foods that are included in the meals available from the food source or generate predicted values of target biomarkers for single foods available from the food source.

In some configurations, instead of generating a prediction of a value (or a change in the value of a biomarker) for a single biomarker, the prediction service generates predictions for values of more than one biomarker. As discussed briefly above, the prediction of the value or the change in the value can be for a biomarker determined objectively (e.g., through a test, measurement by a device, . . . ) or subjectively (e.g., through user input). According to some examples, the prediction service can predict the values for the biomarkers associated with insulin, glucose, ketone bodies, triglycerides, c-peptide, hunger, and the like, for an individual. By combining the predicted values of the biomarkers for a particular food or meal, the prediction service can generate a score for that food or meal.

The prediction service can utilize data received from an individual and data received from other individuals. For example, the prediction service can utilize training data obtained from a number of individuals (e.g., >100, 500, 1000, . . . ). This test group of individuals may be subject to similar tests and procedures thereby providing reliable data that can be utilized by the prediction service and/or the nutrition service. In some configurations, the training data is utilized to train one or more machine learning mechanisms that can be used by the prediction service and/or the nutrition service.

A nutrition service is configured to generate nutritional recommendations that are personalized for the user. The nutrition service communicates with the prediction service in generating the nutritional recommendations for the user. In some examples the nutrition service takes objectives (e.g., reduce weight, avoid high blood glucose levels, avoid cardiovascular disease, move the microbiome towards a target microbiome . . . ) and calculates target outcomes or ranges for one or more biomarkers. The nutrition service utilizes the predictions to generate the nutritional recommendations for the food source based on the objectives, preferences from the user (e.g., the user does not like certain foods or likes certain foods), as well as other data such as the daily meals should total X calories, contain X servings of vegetables, have X amount of fiber content, and the like. In some cases, the nutrition service uses scientific evidence about population-level responses to particular foods or categories of food such as processed meat or alcohol as an input into the recommendation.

Using the technologies described herein, an individual is provided with accurate, personalized food choices for the foods that are available from the food source. This means that an individual does not need to understand the nutritional details of each food which are highly complex and can be overwhelming when faced with a large set of food choices. Instead of just providing an individual with the nutritional content of a meal or a food item, the nutrition service may provide a scoring or ranking of the meals/foods that are available from the food source and are personalized for the individual. As an example, after generating the predictions, the nutrition service can provide the recommendations within a graphical user interface that is presented to the individual, for example on their smartphone. In some cases, the meals/foods that are shown to the user may be limited to simplify the ability of the user to choose food that meets their requirements. By hiding meals that score less well for that individual it can make it easier for them to follow their own diet. In some cases, the scoring reflects recent activity by the user such as sleep and exercise. In some cases, the recommendation could include ways to alter a specific meal the individual wants to eat so as to make it better for that individual. For example, adding avocado to bread to reduce its glycemic response or changing quantities. In some cases, the recommendation may be to choose a different restaurant in the locality which is better suited to that individual's food responses. In this way, the individual can make nutritional choices that are personalized for their objectives/needs. As such, an individual may be able to reduce weight, improve their metabolism and microbiome, avoid obesity and improve health outcomes including diseases such as cardiovascular disease, type 2 Diabetes, metabolic syndrome and the like more effectively as compared to following nutritional recommendations aimed at the general population.

In some cases, the recommendation can be automatically shared with third parties, when authorized (e.g. by an individual). In this way a food delivery service or grocery store can automatically show individually personalized foods to the user based on their own requirements, or automatically generate food optimized for the user such as a week's worth of prepared food and recipes, or a grocery delivery with the best types of meat, vegetables, spreads and bread for that individual.

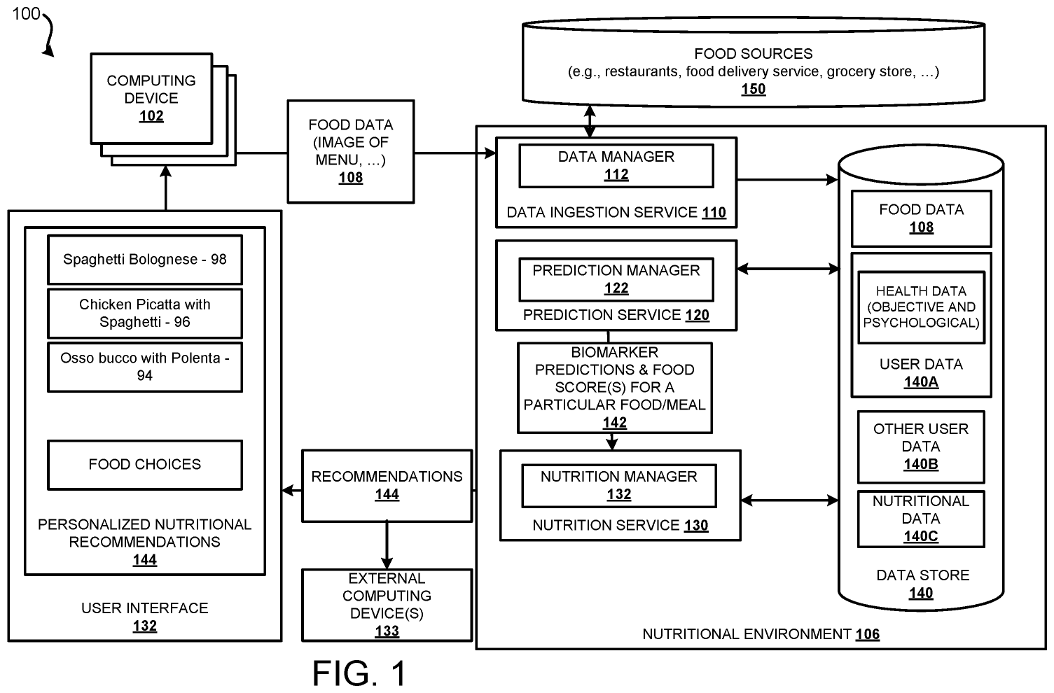

Additional details regarding the various components and processes described above relating to generating food recommendations from different sources will be presented below with regard to FIGS. 1-10.

It should be appreciated that the subject matter presented herein may be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures and other types of structures that perform particular tasks or implement particular abstract data types.

Those skilled in the art will also appreciate that aspects of the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-readers, mobile telephone devices, tablet computing devices, backend servers, special-purposed hardware devices, network appliances and the like.

In the following detailed description, references are made to the accompanying drawings that form a part hereof, and that show, by way of illustration, specific examples or examples. The drawings herein are not drawn to scale. Like numerals represent like elements throughout the several figures (which may be referred to herein as a “FIG.” or “FIGS.”).

FIG. 1 is a block diagram depicting an illustrative operating environment 100 in which food recommendations are generated from different sources. A user, such as an individual requesting personalized food recommendations for foods available from a food source may communicate with the nutritional environment 106 using a computing device 102. In some configurations, the user is a customer of the nutritional environment 106.

As illustrated in FIG. 1, the operating environment 100 includes one or more computing devices 102 in communication with a nutritional environment 106. In some examples, the nutritional environment 106 may be associated with and/or implemented by resources provided by a service provider network such as provided by a cloud computing company. The nutritional environment 106 includes a data ingestion service 110, a prediction service 120, a nutrition service 130, and a data store 140.

The nutritional environment 106 may include a collection of computing resources (e.g., computing devices such as servers). The computing resources may include a number of computing, networking and storage devices in communication with one another. In some examples, the computing resources may correspond to physical computing devices and/or virtual computing devices implemented by one or more physical computing devices.

It should be appreciated that the nutritional environment 106 may be implemented using fewer or more components than are illustrated in FIG. 1. For example, all or a portion of the components illustrated in the nutritional environment 106 may be provided by a service provider network (not shown). In addition, the nutritional environment 106 could include various Web services and/or peer-to-peer network configurations. Thus, the depiction of the nutritional environment 106 in FIG. 1 should be taken as illustrative and not limiting to the present disclosure.

The data ingestion service 110 facilitates submission of data utilized by the prediction service 120 and nutrition service 130. Accordingly, utilizing a computing device 102, a user may submit food data 108 to the nutritional environment 106 via the data ingestion service 110. For example, the user may provide a digital image of a menu, or a portion of a menu, to the data ingestion service 110. In some configurations, such a digital image may be captured using the individual's smartphone camera. The user might also provide the data ingestion service 110 with a link (or some other identifier) that identifies the foods available from the food source or use the smartphone's location services to identify the food source. In other cases, the user might use his computing device to identify particular foods using a barcode or RFID.

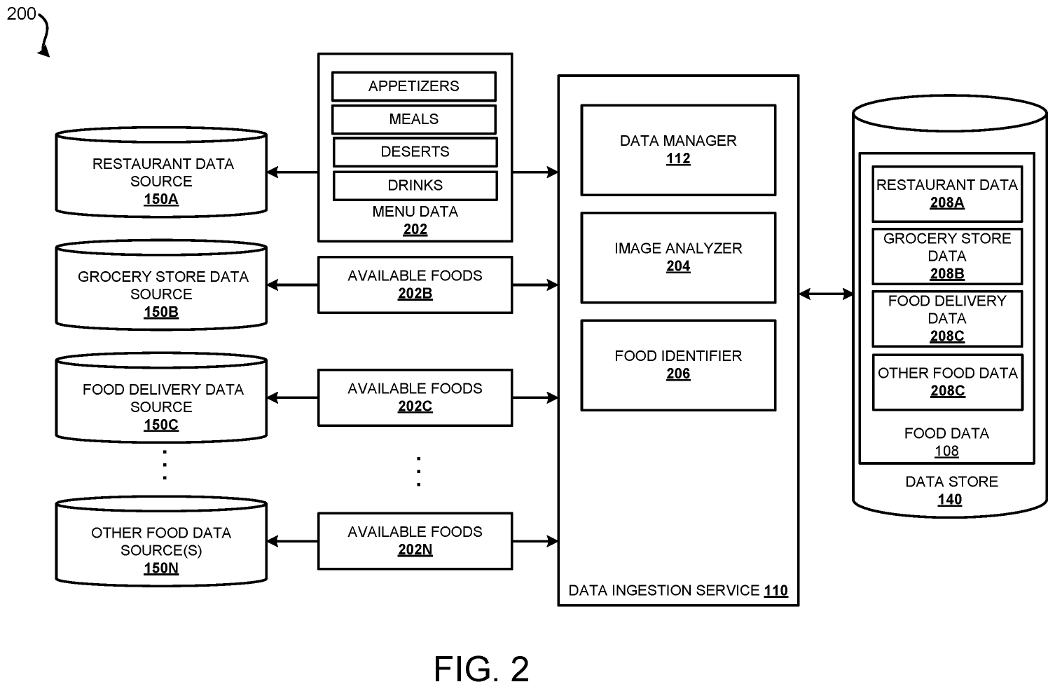

The food data may also be obtained by the data ingestion service 110 from other data sources, such as data source(s) 150. For example, the data source(s) 150 can include, but are not limited to restaurant data sources, grocery store data sources, food delivery data sources, as well as other food data sources such as generic food nutrition databases (See FIG. 2 and related discussion). The food data 108 is utilized to determine the range, price, nutritional data and other aspects of the foods available from a food source.

The data, such as food data 108, or the data obtained from one or more data sources 150, may then be processed by the data manager 112 and included in a data store, such as the data store 140. As illustrated, the data store 140 can be configured to store user data 140A, other user data 140B, and nutritional data 140C (See FIG. 2 for more details on the data ingestion service 110).

In some examples, the user data 140A includes test data and health data that can include psychological data, subjective data and objective health data. In some configurations, other user data 140B may include training data that can be obtained from a number of individuals (e.g., >100, 500, 1000, . . . ). This group of individuals may be subject to similar tests and procedures thereby providing consistent, reliable data that can be utilized by the prediction service 120 and/or the nutrition service 130 for generating personalized nutritional recommendations.

As discussed in more detail below, the prediction service 120 utilizing the prediction manager 122 can predict target values for a plurality of different biomarkers for one or more foods, such as a meal (e.g., lasagna with broccoli) or a snack (e.g., a banana). As discussed briefly above, the prediction service 120 generates predicted values for all or a portion of the foods available from a food source. For instance, the prediction service can provide a ranking of the meals/foods that are available from a particular restaurant, food delivery service, grocery store and the like. The prediction service 120 can be configured to generate a predicted value for each of the biomarkers and/or configured to generate a prediction on how much a value of each of the biomarkers will change based on the food(s) being analyzed. In some examples, the prediction may be for biomarkers determined objectively (e.g., through a test, measurement by a device, . . . ). In other examples, the prediction may be for biomarkers subjectively determined (e.g., through input from the individual). According to some examples, the prediction service 120 predicts the values for the biomarkers associated with insulin, glucose, ketone bodies, triglycerides, c-peptide, IL-6 inflammation, hunger, fullness, mood, and the like for an individual. In some cases, the prediction service 120 predicts slower changing biomarkers such as weight or microbiome composition for the individual.

In some examples, the prediction manager 122 may utilize one or more machine learning mechanisms. For example, the prediction manager 122 can use a classifier (not shown) to classify the predicted value of a biomarker within a classification category. In other examples, the prediction manager 122 may use a scorer (not shown) to generate a score that provides an indication of how likely one or more foods is likely to affect one or more of the target biomarkers. In some configurations, the prediction manager 122 combines the different predictions to generate a single score for the food(s). In other configurations, the prediction manager 122 provides the individual predictions for each of the different biomarkers. According to some examples, the prediction service provides the biomarker predictions and/or food scores for a particular food meal 142 to the nutrition service 130.

The nutrition service 130, or some other service or component, can generate one or more user interfaces, such as a user interface 132, through which a user, utilizing the computing device 102, or some other computing device (e.g., a smartphone), may provide/receive the information via the nutritional environment 106. For example, the nutrition service 130 may provide the personalized food recommendations 144 via the user interface 104. In the illustrated example, the nutrition service 130 provided a ranking of the meals available from a food source (e.g., a restaurant, food delivery service, or some other source). As illustrated, the user interface 132 displays a ranked list of the meals from the food source along with a score of the meal that is personalized for the user.

The prediction service 120 can predict values for one or a plurality of different biomarkers. In some examples, the prediction service 120 predicts the values of insulin, glucose, ketone bodies, c-peptide, IL-6 inflammation and triglycerides after a meal. Insulin, glucose and triglycerides are components that can affect body weight. An individual whose concentrations of these biomarkers spike regularly above the average level is likely to be predisposed to weight-gain, owing to an elevated systemic energy content (glucose and triglycerides) and the capacity to store these substrates (owing to the abundance of insulin).

According to some configurations, the nutrition service 130 utilizes predicted values of the biomarkers generated by the prediction manager 122 of the prediction service 120, along with the user data 140A, other user data 140B, and/or nutritional data 140C, to generate a meal plan for the user. In other examples, the nutrition service 130 generates recommendations for a single meal/snack. As such, an individual may be able to reduce weight, improve their metabolism and microbiome, avoid obesity and improve health outcomes including diseases such as cardiovascular disease, type 2 Diabetes, metabolic syndrome and the like more effectively as compared to following nutritional recommendations aimed at the general population.

In addition, to determining foods that are healthy for a particular individual, the nutrition service 130 can utilize the data to assist in moving biomarkers (e.g., the gut microbiome) toward a target. For example, the nutrition service 130 can be configured to identify foods that move the microbiome of an individual to a target microbiome “fingerprint”. Targeting microbiome improvements for an individual can lead to an improvement of an individual's health and or their responses to foods. As used herein, the term “fingerprint” refers to a mixture of bacteria in the gut microbiome that are associated with an individual.

The nutrition service 130 communicates with the prediction service 120 in generating the personalized nutrition recommendations 144 for the user. The nutrition service 130 may be configured to generate nutritional recommendations for more than one meal or food. For instance, the nutrition service 130 generates meals for a period of time (e.g., a single meal, a day, a week, a month, a year, . . . ).

The nutrition service 130 can take objectives (e.g., reduce weight, avoid high blood glucose levels, avoid cardiovascular disease, move the microbiome towards a target microbiome, sustain energy levels, avoid hunger, . . . ) and calculate target outcomes or ranges for one or more biomarkers. In some configurations, the nutrition service 130 can take objectives that specify specific target values and/or a range of values for one or more biomarkers.

In some examples, the nutrition service 130 utilizes the prediction service 120 to generate predictions of values (or changes in values) for one or more biomarkers for different food choices. For instance, the nutrition service 130 can instruct the prediction service 120 to generate predictions for five, ten, twenty, thirty, or more combination of food choices for one or more meals.

In some examples, the nutrition service 130 can generate nutritional recommendations based on the objectives for the biomarkers, the predictions generated by the prediction service 120, preferences from the user (e.g., the user does not like certain foods or likes certain foods), as well as other data such as the daily meals should total X calories, contain X number servings of vegetables, have X amount of fiber content, and the like. The nutrition service 130 can also use health information such as allergies and intolerances, and dietary restrictions such as vegan or kosher.

The nutrition service 130 can generate one or more user interfaces, such as a user interface 132, through which a user, utilizing the computing device 102, or some other computing device for example their smartphone, may provide/receive the information via the nutritional environment 106. For example, the nutrition service 130 may provide the personalized nutritional recommendations 144 via the user interface 132.

The nutrition service 130, when authorized (e.g., by an individual) may provide the personalized nutritional recommendations 144 automatically to third parties, via an output to external computing device(s) 133. This allows a third party, such as a provider of meal kits or grocery delivery service, to automatically use the user's recommendations in the products they display or deliver to the user. Acting on food recommendations is often the biggest challenge with lifestyle changes, so this can further help with adherence to recommendations.

While the data ingestion service 110, the prediction service 120, and the nutrition service 130 include components illustrated within each of the services, all or a portion of these services may be located in other locations or together with other components. For example, the data ingestion service 110 may be located within the prediction service 120. Similarly, the prediction manager 122 may be part of a different service, and the like.

The prediction service 120 and the nutrition service 130 may utilize one or more mechanisms for predicting the values of target biomarkers and generating the personal nutritional recommendations. For example, and without limitation, the prediction manager can classify the predicted score of each of the biomarkers into a classification category. For example, the predicted score for a biomarker may be classified into a classification category indicating that the predicted value is within a healthy range or a non-healthy range. Alternatively, the classification category may be predicted directly by a classifier without using an intermediate predicted score. A logistic regression mechanism, random forests, gradient boosting, neural networks or some other type of mechanism may be used by the classifier for direct prediction of a classification category. Similarly, the nutrition manager 132 can utilize a classifier to classify a food within a classification category (e.g., recommended/not-recommended).

In other examples, a scorer may utilize another type of mechanism. According to some configurations, the prediction service 120 may utilize a scorer to generate a score (e.g., a numerical value) for the predicted value of each of the target biomarkers. A linear regression mechanism, random forests, gradient boosting, neural networks or some other type of mechanism, may be used by the scorer to generate a score for the predicted value of the biomarker. Any such mechanism can also be utilized by the scorer.

In some configurations, the parameters utilized by the classifier and/or the scorer may be adjusted by a machine learning mechanism. The term “machine learning” may refer to one or more programs that learns to model the relationship between variables from the training data it receives. For example, a machine learning mechanism may build, modify or otherwise utilize a model that is created from example inputs and makes predictions or decisions using the model. In the current example, a machine learning mechanism may be used to identify recommended foods for a particular user and/or predict the value of a biomarker. The model used by the machine learning mechanism may be trained using supervised and/or unsupervised learning. For instance, over time as the machine learning mechanism receives more data, the predicted values and/or the recommended foods that are identified may change based on actual data associated that is received. Different machine learning mechanisms may be utilized. For example, classification or regression approaches using mechanisms such as linear regression, logistic regression, random forests, gradient boosting, neural networks or some other type of mechanism may be utilized. Such machine learning mechanisms might adjust model parameters to improve a least squares fit, achieve a maximum-likelihood estimation, reduce a loss function, or following another approach.

FIG. 2 is a block diagram depicting an illustrative operating environment 200 in which a data ingestion service 110 receives and processes data from different food sources associated with generating food recommendations. As illustrated in FIG. 2, the operating environment 200 includes the data ingestion service 110 that may be utilized in ingesting data utilized by the prediction service 120 and the nutrition service 130.

In some configurations, the data manager 112 is configured to receive from different food data sources such as, but not limited to restaurant data sources 150A, grocery store data sources 150B, food delivery data sources 150C, and other food data sources 150N. The restaurant data source 150A includes food data available from one or more restaurants. For instance, the restaurant data source 150A can include menu data 202 that includes foods that are served at a restaurant. The foods can include appetizers, meals, deserts, drinks, as well as other foods available from a restaurant. In some configurations, the food data sources used may be selected with regard to the individual's location, for example nearby restaurants or grocery stores. In some configurations, this location may be obtained via their smartphone, for example by GPS. Location can allow automatic identification of the food sources or generate a short list of sources for the user to choose from.

As discussed above, a user may capture one or more images of a menu from a food source and provide the image(s) to the data ingestion service 110 for analysis to identify the available meals/foods. In some configurations, the data manager 112 utilizes an image analyzer 204 to identify the available meals/foods. For instance, the image analyzer analyzes the one or more images to extract text/images from the image(s) of the menu.

The data manager 112 can utilize the food identifier 206 to identify the different foods from the text/images. For example, the food identifier 206 can identify that spaghetti marinara is served from an image/text and then identify that this meal includes noodles, and sauce. This data can then be saved in a data store, such as data store 140 and utilized by the prediction service 120 to generate the personalized recommendations. As illustrated, the data ingestion service 110 can be configured to store restaurant data 208A, grocery store data 208B, food delivery data 208C, and other food data 208N.

The grocery store data source 150B includes foods that are available from a grocery store, or market that sells foods. The grocery store data 150B might be divided into categories such as fruits, vegetables, canned goods, and the like. In many cases, the available foods from a grocery store can be accessed via a website or from a reference database.

The food delivery data source 150C includes foods that are available from a food delivery service. For example, the food delivery service might provide pre-packaged meals, grocery delivery or individual foods. In many cases, the available foods from a food delivery service be accessed via a website or from a reference database. In other examples, the user can provide food data associated with the food delivery source by making available one or more images that is used to identify the available foods.

The other food data source(s) 150N includes foods that are available from some other food data source. For example, the other food data source 150N might include foods that are available on a buffet, provided at a banquet, already in the user's kitchen, and the like. In other examples, the user can provide food data associated with the other food data source by making available one or more images that is used to identify the available foods. In some examples, the image analyzer 204 can be configured to identify foods from images of the foods. For instance, a user might capture one or more images of the foods in a buffet, for example using their smartphone camera.

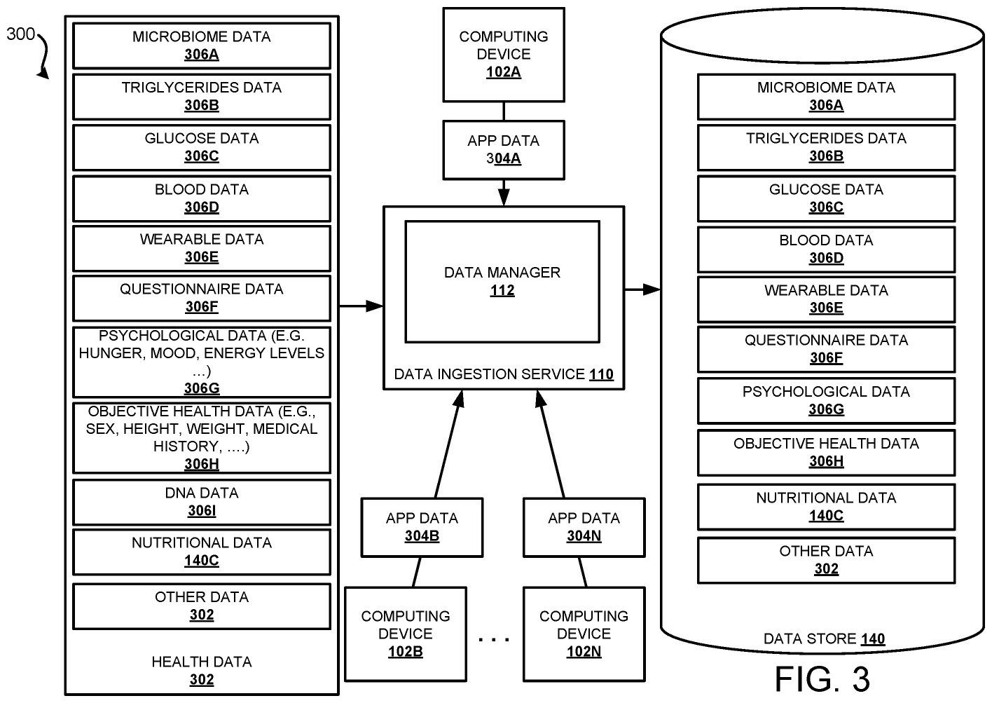

FIG. 3 is a block diagram depicting an illustrative operating environment 300 in which a data ingestion service 110 receives and processes data from different sources associated with generating food recommendations. As illustrated in FIG. 3, the operating environment 300 includes the data ingestion service 110 that may be utilized in ingesting data utilized by the prediction service 120 and the nutrition service 130.

In the configuration illustrated in FIG. 3, the data ingestion service 110 can be configured to receive health data 302 such as, but not limited to microbiome data 306A, triglycerides data 306B, glucose data 306C, blood data 306D, wearable data 306E, questionnaire data 306F, psychological data 306G (e.g., hunger, sleep quality, mood, . . . ), objective health data 306H (e.g., height, weight, medical history, . . . ), nutritional data 140C, and other data 302. According to some examples, the microbiome data 306A includes data about the gut microbiome of an individual. The gut microbiome can host a large number of microbial species (e.g., >1000) that together have millions of genes. Microbial species include bacteria, fungi, parasites, viruses, and archaea. Imbalance of the normal gut microbiome has been linked with gastrointestinal conditions such as inflammatory bowel disease (IBD) and irritable bowel syndrome (IBS), and wider systemic manifestations of disease such as obesity and type 2 diabetes. The microbes of the gut undertake a variety of metabolic functions and are able to produce a variety of vitamins, synthesize essential and nonessential amino acids, and provide other functions. Amongst other functions, the microbiome of an individual provides biochemical pathways for the metabolism of nondigestible carbohydrates; some oligosaccharides that escape digestion; unabsorbed sugars and alcohols from the diet; and host-derived mucins.

The triglycerides data 306B may include data about triglycerides for an individual. In some examples, the triglycerides data can be determined from a blood test and/or from a finger prick on to a dried blood spot card. The glucose data includes data about blood glucose. The glucose data may be determined from various testing mechanisms, such as a continuous glucose meter.

The blood data 306C may include blood tests relating to a variety of different biomarkers. In some configurations, the blood data is associated with measuring blood sugar, insulin, triglycerides, c-peptide, IL-6 inflammation, amylase, ketone bodies, nutrient levels, allergy sensitivities, iron levels, blood count levels, HbAlc, and the like.

The wearable data 306E can include any data received from a computing device associated with a user. For instance, an individual may wear a fitness device, such as an activity-monitoring device, that monitors motion, heart rate, determines how much a user has slept, the number of calories burned, activities performed, blood pressure, body temperature, and the like. The individual may also wear a continuous glucose meter that monitors blood glucose levels.

The questionnaire data 306F can include data received from one or more questionnaires, and/or surveys received from one or more individuals. The psychological data 306G, that may be subjectively obtained, may include data received from the individual and/or a computing device that generates data or input based on a subjective determination (e.g., the individual states that they are still hungry after a meal, or a device estimates sleep quality based on a movement of the user at night). The objective health data 306H includes data that can be objectively measured, such as but not limited to height, weight, medical history, and the like. The DNA data 306I can contain the DNA of the user. Other data 302 can contain health data from other sources such as saliva.

The nutritional data 140C can include data about food. For example, the nutritional data 140C can include nutritional information about different food(s) such as their macronutrients and micronutrients or the bioavailability of its nutrients under different conditions (raw vs cooked, or whole vs ground up). The other data can include other data associated with the individual or other individuals. For example, the other data can include questionnaire data that can be received directly from a computer application that logs information for a user (e.g., food eaten, sleep, . . . ) and/or from the user via a user interface. In some examples, the other data includes preferences, such as favorite foods, and disliked foods specified by an individual.

In some examples, different computing devices 102 associated with different users provide application data 304 to the data manager 112 for ingestion by the data ingestion service 110. As illustrated, computing device 102A provides app data 304A to the data manager 112, computing device 102B provides app data 304B to the data manager 112, and computing device 102N provides app data 304N to the data manager 112.

As discussed briefly above, the data manager 112 receives data from different data sources, processes the data when needed (e.g., cleans up the data for storage in a uniform manner), and stores the data within one or more data stores, such as the data store 140.

The data manager 112 can be configured to perform processing on the data before storing the data in the data store 140. For example, the data manager 112 may receive data for ketone bodies and then use that data to generate ketone body ratios. Similarly, the data manager 112 may process food eaten and generate meal calories, number of carbohydrates, fat to carbohydrate rations, how much fiber consumed during a time period, and the like.

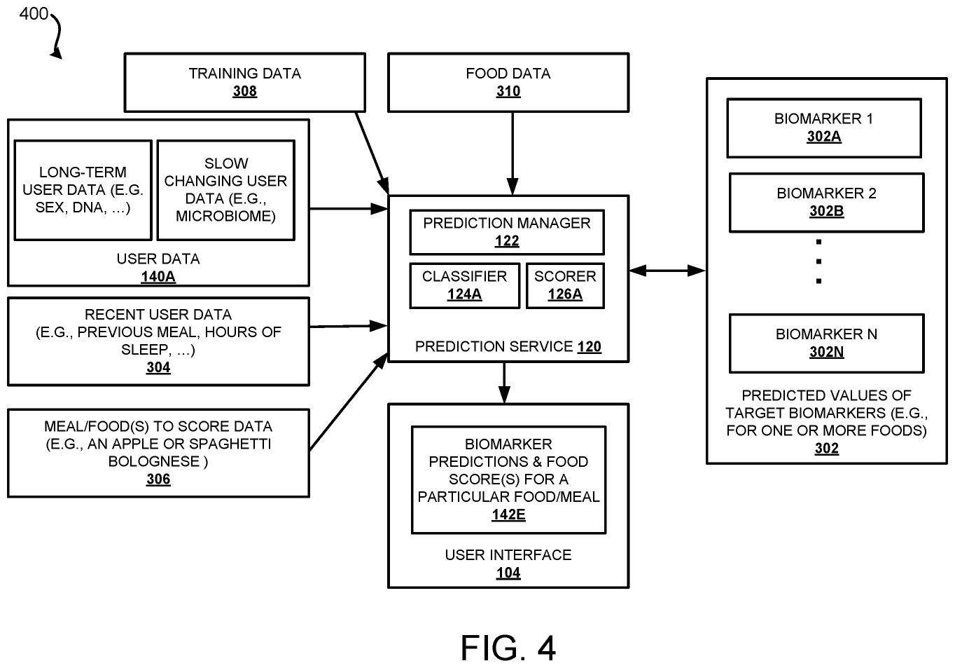

FIG. 4 is a block diagram depicting an illustrative operating environment 300 in which a prediction service 120 generates prediction of target biomarkers (302A-302N) utilizing machine learning or some other scoring system and data. As illustrated in FIG. 4, the operating environment 400 includes the prediction service 120 that includes prediction manager 122, classifier 124A and scorer 126A.

As illustrated, the prediction service 120, via the prediction manager 122, receives user data 140A, recent user data 304, food(s) to score data 306, training data 308, and food data 310. The prediction manager 122 utilizes the user data 140A, the recent user data 304, the meal/food(s) to score data 306, the training data 308, the food data 310 and possibly other data (not shown) to predict target values for biomarkers 302 for a particular meal or food. In some configurations, the recent user data may not be considered when ranking foods available from a food source.

As illustrated, the prediction manager 122 generates values for biomarkers 1 (302A) through biomarker N (302N). As discussed above, biomarkers may be measured through a test, a measuring device, and/or through subjective measurement. For example, biomarker 1 (302A) can be a biomarker associated with “glucose levels”, whereas biomarker 2 (302B) can be a biomarker associated with how “hungry” a user reports feeling either before or after a meal.

The user data 140A can include data associated with a particular individual that is relatively slow changing (e.g., microbiome, weight, . . . ) and long-term user data that is static in nature, such as but not limited to birth date, sex, DNA, and the like. The recent user data 304 includes data that is recent in time (e.g., the last 24 hours), such as but not limited to recent food eaten by the individual (e.g., the previous meal of the individual), how much sleep the user has had, activity level, the mood of the individual, the hunger of the individual, and the like. The meal/food(s) to score data 306 includes data identifying the food(s) the prediction service 120 is to utilize when generating the predicted values (or changes in values).

The training data 308 includes data obtained from a group of individuals. In some examples, at least a portion of the training data 308 includes data obtained in a structured environment (e.g., a clinical study). For example, the training data 308 may include a large number of individual data points (e.g., >500 people, >1000 people, >10000 people). Generally, the more individual data points that are included within the training data 308, the more accurate the personalized nutritional recommendations may be. According to some configurations, the training data 308 may expand to include further individual data points. For example, as individuals add data, the training data 308 can be updated automatically and/or manually to include the data. The food data 310 can include data associated with the food(s) to score data 306, such as nutritional data.

As discussed, the prediction service 120 can utilize a machine learning mechanism. The machine learning mechanism can be trained to predict scores for different biomarkers for different food(s). According to some examples, the machine learning mechanism, or some other scoring mechanism weights the different data used to generate the predictions, such that data that is more accurate (e.g., test data received from individuals in a structured setting, such as a hospital setting, or a lab setting) is provided more weight as compared to data that is not as reliable (e.g., a test performed in an un-structured setting, such as at a home setting that is not as reliable as that done in a hospital setting).

In some examples, the prediction service 120 generates a predicted value for a target biomarker, such as biomarker 1 (302A) before moving onto predicting a value for a next biomarker, such as one of biomarker 2-biomarker N.

According to some examples, the prediction manager 122 utilizes the scorer 126A to generate a score (e.g., a numerical value) for the target biomarker. In other examples, the prediction manager 122 utilizes the classifier 124A to place the target biomarker into a category (e.g., very low, low, average, high, very high) or some other category (e.g., a category based on the value of the score). Generally, the value of a biomarker is dependent on the food of the current meal as included within the meal/food(s) to score data 306. For example, the meal/food(s) to score data 306 can include data indicating that the user ate a banana and spaghetti noodles. In some configurations, the biomarkers predicted are biomarkers that change within some predetermined amount of time from ingestion of the meal (e.g., within a few hours). In many cases, a biomarker can affect a slower moving biomarker, for example HbAlc is a slow moving biomarker affected over weeks by the fast moving biomarker blood glucose.

As briefly discussed above, the prediction service 120 can generate one or more user interfaces, such as a user interface 104, through which a user, utilizing the computing device 102, or some other computing device for example their smartphone, may interact with the prediction service 120 and input or view data, such as the biomarker predictions & food score(s) 142E for a particular food/meal via the user interface 104.

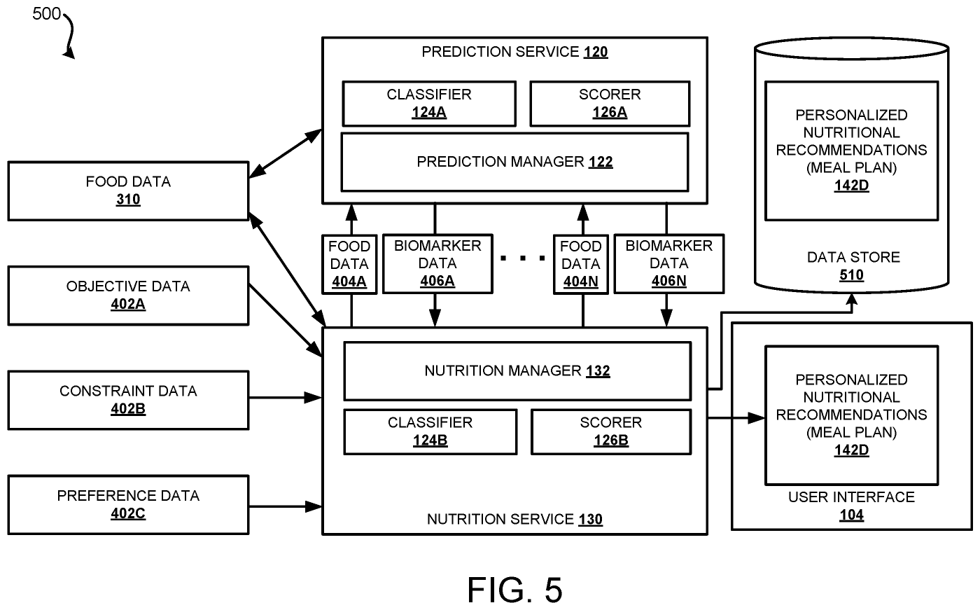

FIG. 5 is a block diagram depicting an illustrative operating environment 500 in which a nutrition service 130 generates personalized nutritional recommendations which may utilize predicted values of target biomarkers. As illustrated in FIG. 5, the operating environment 500 includes the prediction service 120, and the nutrition service 130 that includes nutrition manager 132, classifier 124B and scorer 126B.

The nutrition service 130 is configured to receive objective data 402A, constraint data 402B, preference data 402C, and food data 310. The nutrition service 130 also receives predicted values of target biomarker data (406A-406N) from the prediction service 120. As discussed above, the nutrition manager 132 uses the prediction service 120 to generate predicted values of target biomarkers for different foods when generating the personalized nutritional recommendations 142D for a particular user. The nutrition manager 132 can determine how a variety of different foods meet the objectives, constraints, and preferences when generating the personalized nutritional recommendations 142D for foods from a food source.

The objective data 402A includes one or more objectives for the nutritional recommendations for an individual. For example, one objective may be to increase the health of the individual, another objective may be to decrease the weight of an individual, another objective may be to limit glucose to below a specified value, another objective may be to target triglycerides to a specific value, and the like. Other objectives may be to improve sleep quality, whereas yet another objective may be to decrease cholesterol. In some configurations, where the objective is not for a target value or target range for one or more biomarkers, the nutrition manager 132 can map the objective to a target value or target range for one or more biomarkers (for example a cardiovascular health or liver health objective may be mapped to targeting the biomarker triglycerides to remain below a certain level).

The constraint data 402B indicates the constraints that are associated with the nutritional recommendations of the individual. For example, constraints may include limits, or ranges for different nutritional aspects (e.g., carbohydrates, fat, protein, . . . ), restrictions on type of foods (e.g., a specified number of servings of vegetables per day), how many calories to eat, requirements for variety in meals, and the like. The constraint data 402B may also include individual food allergies, food intolerances, medical guidance on food and absolute food restrictions such as being vegan or kosher.

The preference data 402C indicates the preferences of the user. For example, an individual may provide a list of favorite foods, types of foods, restaurants, recipes, preferred preparation/cooking time, and the like. In this way, the nutrition manager 132 can balance the likes/dislikes of the individual with the objectives for the nutritional recommendations 142D. In some configurations, the recommendations may be selected with regard to the individual's location, for example nearby restaurants. In some configurations, this location may be obtained via their smartphone, for example by GPS.

The food data 310 may include scientific evidence about population-level responses to particular foods or categories of food such as interventional or epidemiological studies of the health risks associated with food such as processed meat or alcohol. The nutrition service 130 may use this non-personalized data as an element in its mechanism to select foods.

As discussed above, the nutrition service 130 can utilize the predicted values of the target biomarkers data 406A generated by the prediction manager 122 of the prediction service 120, along with other data such as the food data 310, the objective data 402A, the constraint data 402B, the preference data 402C and/or other data discussed herein, to generate personalized nutritional data recommendations 142D for the individual. As discussed above, the nutrition service 130 can provide the personalized nutritional recommendations 142D via the user interface 104 that can be presented on a display associated with a computing device, such as computing device 102. The nutrition service 130 may also provide the personalized nutritional recommendations automatically, when authorized, to one or more data stores, such as data store 502. The data store 502 can be associated with one or more third parties. For example, the data store 502 may be a data store associated with the external computing device(s) 133 illustrated in FIG. 1.

The nutrition service 130 is configured to provide an individual with personalized food choices. As such, an individual may be able to reduce weight, improve their metabolism and microbiome, avoid obesity and improve health outcomes including diseases such as cardiovascular disease, type 2 Diabetes, metabolic syndrome and the like more effectively as compared to following nutritional recommendations aimed at the general population.

In addition, to determining foods that are healthy for a particular individual, the nutrition service 130 can utilize the data to assist in moving slow moving biomarkers (e.g., the gut microbiome) toward a target. For example, the nutrition service 130 can be configured to identify foods that move the microbiome of an individual towards a target microbiome “fingerprint”. Targeting microbiome improvements for an individual may be able to lead to an improvement of an individual's health and their responses to foods. As used herein, the term “fingerprint” refers to a mixture of bacteria in the gut that are associated with an individual. In some cases, recommendations might include probiotics in addition to food to achieve the desired shift in the microbiome fingerprint.

As discussed above, the nutrition service 130 communicates with the prediction service 120 in generating the personalized nutritional recommendations 142D for the individual. As illustrated, the nutrition service 130 utilizes the prediction service 120 to generate predictions of values (or changes in values) for one or more biomarkers for different food choices, where each choice may be an individual food item or a combinations of food items such as a home-cooked recipe. For instance, the nutrition service 130 can provide food data 404A to the prediction service 120 to generate predictions for one or more different biomarkers for a first food (or meal) and receive biomarker data 406A that provides the generated predictions for the first food. The nutrition service 130 can instruct the prediction service 120 to generate many different combinations of foods when determining the personalized nutritional recommendations. In the current example, the nutrition service 130 has requested N different predictions for N different foods. The nutrition manager 132 may generate nutritional recommendations for a single meal, a days' worth of meals, a weeks' worth of meals, a months' worth of meals, and the like. Generally, the nutrition manager 132 selects foods for particular meals such that the objectives, constraints, and preferences of the user are accounted for when developing the nutritional recommendations 142D.

The nutrition service 130 utilizes a mechanism, such as a machine learning mechanism to generate a selection of the foods to present within the personalized nutritional recommendations 142D. In some examples, the nutrition manager 132 utilizes the classifier 124B and/or the scorer 126B to rank the different food combinations. According to some configurations, the machine learning mechanism utilizes the biomarker data 406 along with the objective data, constraint data, and preference data as inputs to the machine learning mechanism. Stated another way, the nutrition manager 132 utilizes the machine learning mechanism to generate nutritional recommendations 142D based on the objectives of the meals relative to the biomarkers (e.g., keep glucose triglycerides and insulin within these specified ranges, move the microbiome to a target microbiome . . . ), preferences from the user (e.g., the user does not like certain foods or likes certain foods), as well as other data such as the daily meals should total X calories, contain X servings of vegetables, have X amount of fiber content, and the like.

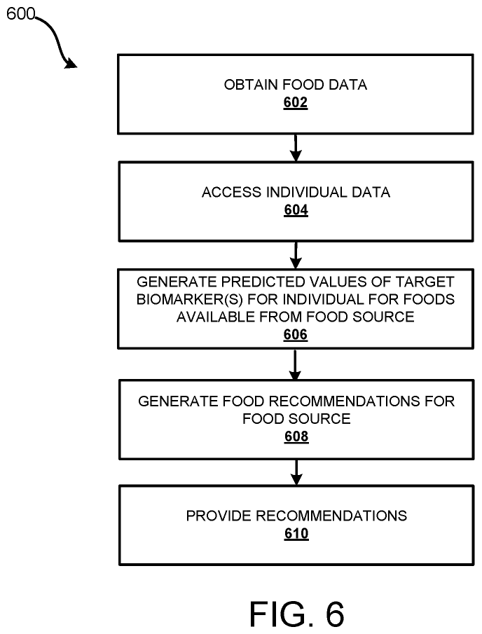

FIGS. 6-9 are flow diagrams showing routines 600, 700, 800, and 900 respectively that illustrate aspects of generating personalized nutritional recommendations for foods available from food sources in accordance with examples described herein. It should be appreciated that the logical operations described herein with respect to FIGS. 6-9, and the other FIGS., may be implemented (1) as a sequence of computer implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic and any combination thereof. It should also be appreciated that more or fewer operations may be performed than shown in the FIGS. and described herein. These operations may also be performed in parallel, or in a different order than those described herein.

FIG. 6 is a flow diagram showing a routine 600 illustrating aspects of a mechanism disclosed herein for generating food recommendations from different food sources. The routine 600 may begin at 602, where food data is obtained and processed. As discussed above, food data is received by the data ingestion service 110, or some other computing device that is associated with the nutritional environment 106.

At 604, individual data is obtained and processed. As discussed above, individual data is received by the data ingestion service 110, or some other computing device that is associated with the nutritional environment 106. Generally, the individual data includes health data associated with the individual.

At 606, predicted values of target biomarker(s) are generated for the available foods from a food source. For example, the prediction service 120 can generate predicted values for each of the menu choices available from a restaurant or some other food source. As discussed above, the target biomarker may be one of a number of different biomarkers. In some configurations, instead of predicting a value of a single biomarker, the prediction service 120 generates a prediction for at least two target biomarkers. The prediction service 120 generates a predicted value (or change in value) of the currently selected target biomarker predicted after eating a particular food, or foods of a meal that is available from a food source. As discussed above, the prediction manager 122 of the prediction service 120 can utilize a machine learning mechanism to generate the predictions.

At 608, food recommendations for a food source are generated. As discussed above, the food recommendations are personalized for a user. For example, the nutrition service 130 can rank the available foods from the food service based on the predicted values of the target biomarkers associated with a particular individual. In other examples, the nutrition service 130 can classify the foods available from the food source into one or more classifications (e.g., healthy, unhealthy or a grading system such as A, B, C . . . ). Other ranking methods can also be utilized. In some example, the nutrition service 130, via the nutrition manager 132 generates a list of meals and/or foods that are recommended for the user based on the predictions of the biomarker values for the different foods available from the food source.

At 610, the recommendations are provided to the user. As discussed above, the nutrition service 130 can provide the recommendations through a user interface 132. The recommendations might also be provided via a speech mechanism, or through some other interface. They may also be automatically shared, when authorized, with third parties via output to external devices 133.

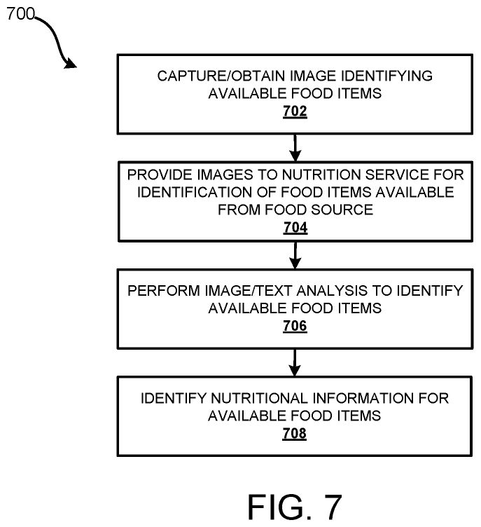

FIG. 7 is a flow diagram showing a routine 700 illustrating aspects of a mechanism disclosed herein for identifying foods from a menu. In some examples, the food source can be automatically determined (e.g., using the location and/or some other identifying characteristic of the store/restaurant/food source) and a menu and/or food items determined utilizing that information. For example, a user may enter a restaurant at a known location. Based on the location, name and/or some other characteristic of the restaurant the available food items can be obtained from a food source (e.g., a website, or some other food database).

The routine 700 may begin at 702, where one or more images of available foods is obtained. As discussed above, a user can provide one or more pictures that are processed by the data ingestion service 110 to identify the available foods from the food source. In some examples, the user takes a picture(s) of a menu. In other examples, the user can take a picture of actual foods that are available from the food source. In yet other examples, the user can take a picture of an identifier, such as a barcode, that is used to identify the food item(s). In some configurations, the user takes these pictures with the camera on their smartphone.

At 704, the images are provided to the nutrition service 130. As discussed above, the image data can be received by the data ingestion service 110, or some other computing device that is associated with the nutritional environment 106. In some configurations, the user uploads the image(s) to the data ingestion service. In other examples, the data ingestion service accesses a location to obtain the image(s).

At 706, image analysis is performed to identify the foods available from the food source. As discussed above, the data ingestion service 110 can utilize an image analyzer, or some other component or device, to perform image analysis to identify the available foods. In some examples, the image analyzer 206 determines the available foods by locating text within the image that identifies foods/meals e.g. from a menu. In other examples, the image analyzer 206 can be configured to identify foods depicted within the image. According to some configurations, the image analyzer can utilize an internal service such as the food identifier 206 and/or an external service to identify the foods depicted within the image. In yet other configurations, the image analyzer can identify the foods from a barcode, or some other identifier, associated with the food item(s).

At 708, nutritional information for the identified foods is identified. As discussed above, the data ingestion service 110 can be configured to associate nutritional information with the identified foods. For example, when an apple is identified, nutrition information (e.g., calories, fat, carbohydrates, sugars, fiber, protein, . . . ) can be associated with the apple.

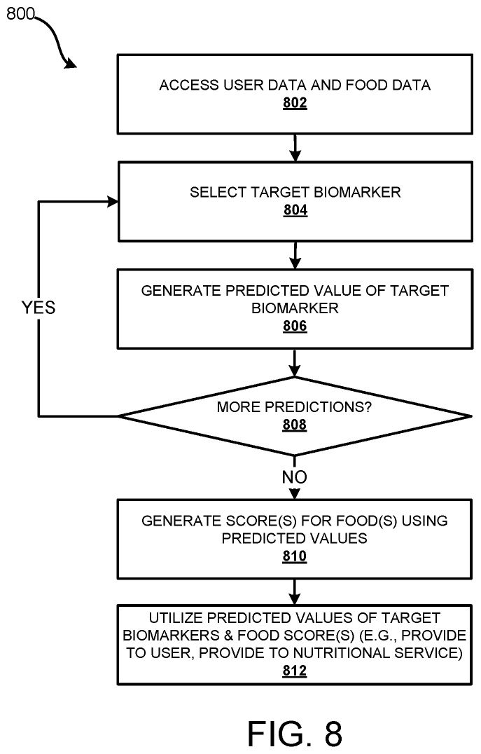

FIG. 8 is a flow diagram showing a routine 800 illustrating aspects of a mechanism disclosed herein for predicting values of target biomarkers. The routine 800 may begin at 802, where user data and food data are accessed and processed. As discussed above, different data is received by the data ingestion service 110, or some other computing device that is associated with the nutritional environment 106. In some examples, the prediction service 120 utilizes user data and food data for generating predictions associated with different biomarkers.

At 804, a target biomarker is selected for prediction. As discussed above, the target biomarker may be one of a number of different biomarkers. In some examples, instead of predicting a value of a single biomarker, such as a glucose biomarker, the prediction service 120 generates a prediction for at least two target biomarkers. In other examples, the prediction service can generate a prediction for a single biomarker or a plurality of biomarkers.

At 806, the prediction service 120 generates a predicted value (or change in value) of the currently selected target biomarker predicted after eating a particular food, or foods of a meal that are available from a food source. As discussed above, the prediction manager 122 of the prediction service 120 can utilize a machine learning mechanism to generate the predictions.

At 808, a determination is made as to whether there are more predictions. When there are more predictions, the process returns to 804. Where there are no further predictions, the process moves to 810.

At 810, the predicted values of the target biomarkers are used to generate score(s) for the current food item(s). According to some configurations, the prediction service 120 and/or the nutrition service 130 can generate a single score for an entire meal available from a food source.

At 812, the generated score(s) and/or the predicted values of the target biomarkers are utilized. In some examples, the nutrition service 130, via the nutrition manager 132 generates a ranking of the available food item(s)/meals available from the food source. In some examples, the ranking is based on a scoring or classification of the food item(s)/meals provided by the prediction service. In other examples, the predictions, rankings and/or score(s) of the food are provided to the user, such as through a user interface 132.

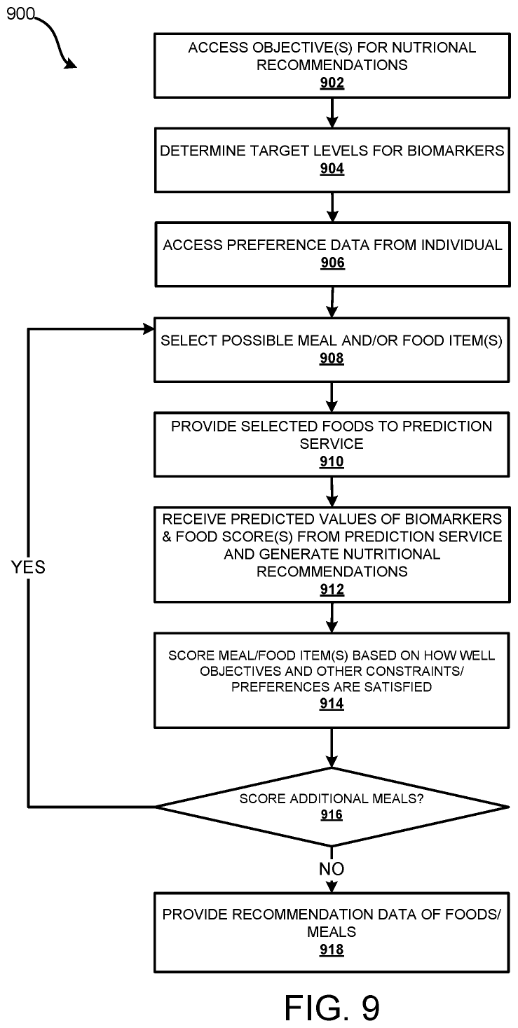

FIG. 9 is a flow diagram showing a routine 900 illustrating aspects of a mechanism disclosed herein for generating personalized nutritional recommendations for foods available from a food source. The routine 900 may begin at 902, where the objective(s) for the nutritional recommendation(s) are set. As discussed above, the objectives can be preset by an authorized user and/or input using an input mechanism, such as a graphical user interface. In some examples, the objectives for the nutritional recommendations are set based on data associated with the user. For example, for an individual that desires blood glucose to stay below a target level, one of the objectives may be to limit a blood glucose response to a predefined level. The objectives can also include other objectives, such as but not limited to weight loss, gut microbiome targeting, triglycerides levels, and the like.

At 904, target levels for biomarkers are determined. As discussed above, in some examples, the objective may specify a target value or a range of target values for specific biomarkers. In other examples, the objective may specify a goal such as improve cardiovascular health, reduce weight, and the like. In these examples where the objective is not for a target value or target range for one or more biomarkers, the routine can map the objective to a target value or target range for one or more biomarkers (for example a cardiovascular health or liver health objective may be mapped to targeting biomarkers such as triglycerides to remain below a certain level).

At 906, preference data for an individual is accessed. As discussed above, the preference data can indicate the preferences of the individual and/or some other authorized individual. For example, the preference data can indicate favorite foods of the individual, foods the individual does not like, and the like.

At 908, a possible meal and/or food item(s) from a food source are selected. For example, a meal from a food source is selected and/or one or more foods available from the food source are selected. As discussed above, the nutrition service 130 can determine the foods within a meal provided by the food service and/or select a number of different foods and combine those foods in different ways when generating a meal recommendation.

At 910, the nutrition service 130 provides the foods to the prediction service. As discussed above, the prediction service 120 generates predicted values of the selected target biomarkers in response to receiving the selected foods from the nutrition service 130 and/or from some other source (e.g., a user interface).

At 912, the predicted values of the biomarkers and/or food score(s) are received from the prediction service 120. As discussed above, the nutrition service 130 generates nutritional recommendations using the predicted values of the biomarkers and/or food score(s) along with the other data, such as the objective data, constraint data, and preference data associated with the individual.

At 914, the meal is scored based on how well the meal satisfies the objectives, constraints, and/or preferences. As discussed above, the score can be used by the user to select the meals/foods from a particular food source.

At 916, a determination is made as to whether one or more additional meals are to be generated. When more meals are to be generated, the process returns to 906. When more meals are not to be generated, the process moves to 916.

At 918, the recommendation data of the foods/meals is provided. In some examples, the recommendation data is provided via a user interface 132 that is displayed on a display associated with the computing device 102. In other configurations, the recommendation data can be included in an email, or some other electronic communication that is delivered to the user or to a third party.

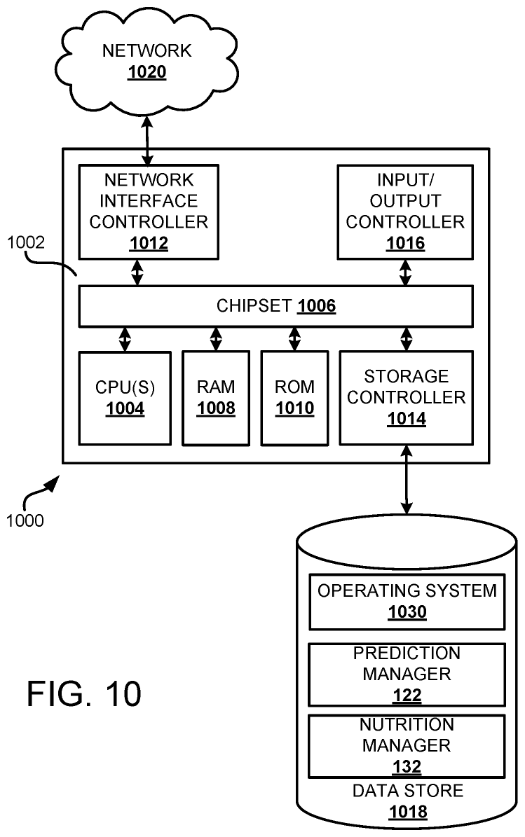

FIG. 10 shows an example computer architecture for a computer 1000 capable of executing program components for generating personalized nutritional recommendations using predicted values of target biomarkers in the manner described above. The computer architecture shown in FIG. 10 illustrates a conventional server computer, workstation, desktop computer, laptop, tablet, network appliance, digital cellular phone, or other computing device, and may be utilized to execute any of the software components presented herein. For example, the computer architecture shown in FIG. 10 may be utilized to execute software components for performing operations as described above. The computer architecture shown in FIG. 10 might also be utilized to implement a computing device 102, or any other of the computing systems described herein.

The computer 1000 includes a baseboard 1002, or “motherboard,” which is a printed circuit board to which a multitude of components or devices may be connected by way of a system bus or other electrical communication paths. In one illustrative example, one or more central processing units (“CPUs”) 1004 operate in conjunction with a chipset 1006. The CPUs 1004 may be standard programmable processors that perform arithmetic and logical operations necessary for the operation of the computer 1000.

The CPUs 1004 perform operations by transitioning from one discrete, physical state to the next through the manipulation of switching elements that differentiate between and change these states. Switching elements may generally include electronic circuits that maintain one of two binary states, such as flip-flops and electronic circuits that provide an output state based on the logical combination of the states of one or more other switching elements, such as logic gates. These basic switching elements may be combined to create more complex logic circuits, including registers, adders-subtractors, arithmetic logic units, floating-point units and the like.

The chipset 1006 provides an interface between the CPUs 1004 and the remainder of the components and devices on the baseboard 1002. The chipset 1006 may provide an interface to a RAM 1008, used as the main memory in the computer 1000. The chipset 1006 may further provide an interface to a computer-readable storage medium such as a read-only memory (“ROM”) 1010 or non-volatile RAM (“NVRAM”) for storing basic routines that help to startup the computer 1000 and to transfer information between the various components and devices. The ROM 1010 or NVRAM may also store other software components necessary for the operation of the computer 1000 in accordance with the examples described herein.

The computer 1000 may operate in a networked environment using logical connections to remote computing devices and computer systems through a network, such as the network 1020. The chipset 1006 may include functionality for providing network connectivity through a network interface controller (“NIC”) 1012, such as a mobile cellular network adapter or gigabit Ethernet adapter. The NIC 1012 is capable of connecting the computer 1000 to other computing devices over the network 1020. It should be appreciated that multiple NICs 1012 may be present in the computer 1000, connecting the computer to other types of networks and remote computer systems.

The computer 1000 may be connected to a mass storage device 1018 that provides non-volatile storage for the computer. The mass storage device 1018 may store system programs, application programs, other program modules and data, which have been described in greater detail herein. The mass storage device 1018 may be connected to the computer 1000 through a storage controller 1014 connected to the chipset 1006. The mass storage device 1018 may consist of one or more physical storage units. The storage controller 1014 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1000 may store data on the mass storage device 1018 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 1018 is characterized as primary or secondary storage and the like.

For example, the computer 1000 may store information to the mass storage device 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1000 may further read information from the mass storage device 1018 by detecting the physical states or characteristics of one or more particular locations within the physical storage units.

In addition to the mass storage device 1018 described above, the computer 1000 may have access to other computer-readable storage media to store and retrieve information, such as program modules, data structures, or other data. It should be appreciated by those skilled in the art that computer-readable storage media is any available media that provides for the non-transitory storage of data and that may be accessed by the computer 1000.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The mass storage device 1018 may store an operating system 1030 utilized to control the operation of the computer 1000. According to one example, the operating system comprises the LINUX operating system. According to another example, the operating system comprises the WINDOWS® SERVER operating system from MICROSOFT Corporation. According to another example, the operating system comprises the iOS operating system from Apple. According to another example, the operating system comprises the Android operating system from Google or its ecosystem partners. According to further examples, the operating system may comprise the UNIX operating system. It should be appreciated that other operating systems may also be utilized. The mass storage device 1018 may store other system or application programs and data utilized by the computer 1000, such as components that include the prediction manager 122, the nutrition manager 132 and/or any of the other software components and data described above. The mass storage device 1018 might also store other programs and data not specifically identified herein.

In one example, the mass storage device 1018 or other computer-readable storage media is encoded with computer-executable instructions that, when loaded into the computer 1000, create a special-purpose computer capable of implementing the examples described herein. These computer-executable instructions transform the computer 1000 by specifying how the CPUs 1004 transition between states, as described above. According to one example, the computer 1000 has access to computer-readable storage media storing computer-executable instructions which, when executed by the computer 1000, perform the various routines described above with regard to FIGS. 6-9. The computer 1000 might also include computer-readable storage media for performing any of the other computer-implemented operations described herein.

The computer 1000 may also include one or more input/output controllers 1016 for receiving and processing input from a number of input devices, such as a keyboard, a mouse, a touchpad, a touch screen, an electronic stylus, or other type of input device. Similarly, the input/output controller 1016 may provide output to a display, such as a computer monitor, a flat-panel display, a digital projector, a printer, a plotter, or other type of output device. It will be appreciated that the computer 1000 may not include all of the components shown in FIG. 10, may include other components that are not explicitly shown in FIG. 10, or may utilize an architecture completely different than that shown in FIG. 10.

Based on the foregoing, it should be appreciated that technologies for generating personalized food recommendations from different food sources have been presented herein. Moreover, although the subject matter presented herein has been described in language specific to computer structural features, methodological acts and computer readable media, it is to be understood that the invention defined in the appended claims is not necessarily limited to the specific features, acts, or media described herein. Rather, the specific features, acts and media are disclosed as example forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the example examples and applications illustrated and described, and without departing from the true spirit and scope of the present invention, which is set forth in the following claims.

What is claimed is:

1. A computer-implemented method, comprising:
obtaining food data associated with foods available from one or more food sources;
accessing health data associated with an individual;
generating, based at least in part on the food data and the health data, first personalized nutrition data for the individual eating a first food or combination of foods from the food sources;
generating, based at least in part on the food data and the health data, second personalized nutrition data for the individual eating a second food or combination of foods from the food sources; and
generating, based at least in part on the food data, the health data, the first personalized nutrition data and/or the second personalized nutrition data, a personalized nutrition recommendation for the individual that identifies a preference of the first food or combination of foods or the second food or combination of foods.

2. The computer-implemented method of claim 1, wherein one or more of the first personalized nutrition data or the second personalized nutrition data include data indicating a value associated with a target biomarker predicted for the individual after eating the first food or combination of foods or the second food or combination of foods.

3. The computer-implemented method of claim 1, wherein obtaining the food data includes accessing a digital image, and identifying at least one food item from an automated graphical analysis of the digital image.

4. The computer-implemented method of claim 1, wherein receiving the health data includes receiving microbiome data associated with the individual.

5. The computer-implemented method of claim 1, wherein generating the first predicted data and the second predicted data comprises utilizing a machine learning mechanism, wherein the machine learning mechanism is trained using health data, food data and measured biomarker responses to eating foods associated with a plurality of users and/or foods.

6. The computer-implemented method of claim 2, wherein more than one target biomarker is predicted.

7. The computer-implemented method of claim 1, wherein generating the personalized nutrition recommendation includes generating one or more scores, rankings or classifications for at least a portion of the foods available from the food sources.

8. The computer-implemented method of claim 1, wherein the food sources include one or more of a restaurant, a food delivery service, or a grocery store.

9. The computer-implemented method of claim 1, wherein the combinations of foods evaluated include one or more recipes associated with ingredients available to the individual.

10. The computer-implemented method of claim 1, wherein preference data associated with the individual is considered when generating the recommendation.

11. The computer-implemented method of claim 1, wherein one or more of the food sources or recommendations are selected with regard to a location of the individual.

12. The computer-implemented method of claim 1, wherein, when authorized by the individual, the recommendations are automatically shared with one or more of a restaurant, a food delivery service, or a grocery store.

13. The computer-implemented method of claim 1, wherein the second food is a modification to the first food designed to make it healthier.

14. The computer-implemented method of claim 1, wherein the recommendations are for a series of meals to be eaten at different occasions.

15. A system, comprising:
a data ingestion service, including one or more processors, configured to
receive food data associated with foods available from one or more food sources;
receive health data associated with an individual, and
a prediction service, including one or more processors, configured to
access the food data associated with foods available from one or more food sources,
access the health data associated with the individual,
generate, based at least in part on the food data and the health data, first personalized nutrition data for the individual eating a first food or combination of foods from the food sources,
generate, based at least in part on the food data and the health data, second personalized nutrition data for the individual eating a second food or combination of foods from the food sources, and
a nutrition service, including one or more processors, configured to generate, based at least in part on the food data, the health data, the first personalized nutrition data and/or the second personalized nutrition data, a personalized nutrition recommendation for the individual that identifies a preference of the first food or combination of foods or the second food or combination of foods.

16. The system of claim 15, wherein receiving the food data includes accessing a digital image, and identifying at least one food item from an automated graphical analysis of the digital image.

17. The system of claim 15, wherein the combinations of foods evaluated include one or more recipes associated with ingredients available to the individual, and wherein preference data associated with the individual is considered when generating the recommendation.

18. A non-transitory computer-readable storage medium having computer-executable instructions stored thereupon which, when executed by a computer, cause the computer to:
access food data associated with foods available from one or more food sources;
access health data associated with an individual;
generate, based at least in part on the food data and the health data, first personalized nutrition data for the individual after eating a first food or combination of foods from the food sources;
generate, based at least in part on the food data and the health data, second personalized nutrition data for the individual after eating a second food or combination of foods from the food sources; and
generate, based at least in part on the food data, the health data, the first personalized nutrition data and/or the second personalized nutrition data, a personalized nutrition recommendation for the individual that identifies a preference of the first food or combination of foods or the second food or combination of foods.

19. The non-transitory computer-readable storage medium of claim 18, wherein the one or more of the first personalized nutrition data or the second personalized nutrition data include data indicating a value associated with a target biomarker predicted for the individual after eating the first food or combination of foods or the second food or combination of foods.

20. The non-transitory computer-readable storage medium of claim 34, wherein obtaining the food data includes accessing a digital image, and identifying at least one food item from an automated graphical analysis of the digital image.
